(19) United States
(12) Patent Application Publication
(10) Pub. No.: US 2004/0107810 A1
(43) Pub. Date: Jun. 10, 2004

(54) Apparatus for generating a high-pressure fluid jet

(75) Inventors: Felix M. Sciulli, Issaquah, WA (US); Mohamed A. Hashish, Bellevue, WA (US); Steven J. Craigen, Auburn, WA (US); Bruce M. Schuman, Kent, WA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Flow International Corporation, Kent, WA (US)

(21) Appl. No.: 10/717,744

(22) Filed: Nov. 20, 2003

Related U.S. Application Data
(62) Division of application No. 10/114,920, filed on Apr. 1, 2002.
Application No. 10/114,920 is a continuation-in-part of application No. 09/940,689, filed on Aug. 27, 2001.

(51) Int. Cl. B26F 3/00

(52) U.S. Cl. 83/177; 451/102

(57) ABSTRACT

An improved apparatus for generating a high-pressure fluid jet includes an orifice mount having a frusto-conical surface that engages a frusto-conical wall in a cutting head, the geometry of the orifice mount and cutting head being selected to increase the stability of the mount and reduce deflection of the mount adjacent a jewel orifice, when subjected to pressure. Alignment of a nozzle body and the cutting head is improved by providing pilot diameters both upstream and downstream of threads on the nozzle body and bore of the cutting head, respectively. Accurate placement of a mixing tube in a cutting head is achieved by rigidly fixing a collar to an outer surface of the mixing tube, the collar engaging a shoulder and bore of the cutting head downstream of a mixing chamber, to precisely locate the mixing chamber axially and radially.

### CROSS-REFERENCE TO RELATED APPLICATIONS

This application is a divisional of U.S. patent application Ser. No. 10/114,920, filed Apr. 1, 2002, which is currently pending. U.S. patent application Ser. No. 10/114,920 is a continuation-in-part of U.S. patent application Ser. No. 09/940,689, filed Aug. 27, 2001, also currently pending. These applications are incorporated herein by reference in their entirety.

### BACKGROUND OF THE INVENTION

1. Field of the Invention

The present invention relates to an apparatus for generating a high-pressure fluid jet, including an apparatus for generating a high-pressure abrasive waterjet.

2. Description of the Related Art

High-pressure fluid jets, including high-pressure abrasive waterjets, are used to cut a wide variety of materials in many different industries. Systems for generating high-pressure fluid jets are currently available, for example the Paser 3 system manufactured by Flow International Corporation, the assignee of the present invention. A system of this type is shown and described in Flow's U.S. Pat. No. 5,643,058, which patent is incorporated herein by reference. In such systems, high-pressure fluid, typically water, flows through an orifice in a cutting head to form a high-pressure jet. If desired, abrasive particles are fed to a mixing chamber and entrained by the jet as the jet flows through the mixing chamber and a mixing tube. The high-pressure abrasive waterjet is discharged from the mixing tube and directed toward a workpiece to cut the workpiece along a selected path.

Various systems are currently available to move a high-pressure fluid jet along a selected path. (The terms “high-pressure fluid jet” and “jet” used throughout should be understood to incorporate all types of high-pressure fluid jets, including but not limited to, high-pressure waterjets and high-pressure abrasive waterjets.) Such systems are commonly referred to as two-axis, three-axis and five-axis machines. Conventional three-axis machines mount the cutting head assembly on a ram that imparts vertical motion along a Z-axis, namely toward and away from the workpiece. The ram, in turn, is mounted to a bridge via a carriage, the carriage being free to move parallel to a longitudinal axis of the bridge in a horizontal plane. The bridge is slideably mounted on one or more rails to move in a direction perpendicular to the longitudinal axis of the bridge. In this manner, the high-pressure fluid jet generated by the cutting head assembly is moved along a desired path in an X-Y plane, and is raised and lowered relative to the workpiece, as may be desired. Conventional five-axis machines work in a similar manner but provide for movement about two additional rotary axes, typically about one horizontal axis and one vertical axis.

Applicants believe it is desirable and possible to provide an improved system for generating a high-speed fluid jet. The present invention provides such a system.

### BRIEF SUMMARY OF THE INVENTION

Briefly, the present invention provides an improved system for generating a high-pressure fluid jet, for example a high-pressure abrasive waterjet. More particularly, the improved apparatus of the present invention includes a cutting head assembly that carries both an orifice in an orifice mount for generating a high-pressure fluid jet, and a mixing tube positioned within the body of the cutting head downstream of the orifice. The cutting head is coupled to a source of high-pressure fluid through a nozzle body, and may also be coupled to a source of abrasive, to generate a high-pressure or high-speed abrasive fluid jet, as is known in the art.

In accordance with the present invention, the orifice mount has a frusto-conical outer surface that seats against a corresponding frusto-conical wall formed in a bore of the cutting head. As described previously in U.S. Pat. No. 5,643,058, it is desirable for the frusto-conical surface of the orifice mount to form an included angle of 55-80°. However, applicants have improved the performance of the orifice mount by reducing the length of the frusto-conical surface, such that a radial distance between the midpoint of the frusto-conical surface and the longitudinal axis or centerline of the orifice mount is reduced, as compared to previously available mounts. The length of the corresponding frusto-conical bearing surface in the cutting head is also reduced, as compared to conventional systems, and in a preferred embodiment, is less than the length of the frusto-conical surface of the orifice mount. By minimizing the distance between the longitudinal axis of the assembly, which corresponds to the longitudinal axis or centerline of the orifice mount and the cutting head, and the center points of the bearing surfaces of the cutting head and the orifice mount, deflection of the mount under pressure is reduced. A distance between the midpoint of the frusto-conical surface of the orifice mount and a top surface of the orifice mount is also maximized to increase the stability of the orifice mount under pressure. By providing apparatus in accordance with the present invention, the wear characteristics and accuracy of the assembly are improved, thereby reducing cost and improving the overall performance of the system.

In accordance with a preferred embodiment of the present invention, a collar is rigidly fixed to an outer surface of the mixing tube in an upper region of the mixing tube. The bore of the cutting head forms a shoulder downstream of a mixing chamber in the cutting head, and flares outward, from a point downstream of the shoulder to the distal end of the cutting head. The collar on the mixing tube is sized to slide upward through the bore of the cutting head and seat against the shoulder of the cutting head. Because the collar is rigidly fixed to the outer surface of the mixing tube, it locates the mixing tube in a selected, specific longitudinal position, when the collar registers against the shoulder, thereby preventing the mixing tube from being inserted any farther into the cutting head.

The collar may be cylindrical, and supported by a collet that is positioned around the mixing tube and inserted into the flared end of the cutting head bore. Alternatively, the collar may be substantially frusto-conical, such that it both seats against the shoulder and mates with the conical surface of the bore, thereby locating the mixing tube both longitudinally and radially. In this manner, the mixing tube may be located precisely within the cutting head, wholly eliminating the need for a pin, insert, or other device known in the art to register the mixing tube. In this manner, manufacturing is more simple and cost effective, and the volume of the mixing chamber is not impinged upon by a pin or insert, etc. Furthermore, it will be understood that the collar may be rigidly fixed to an outer surface of the mixing tube at any desired point along the length of the mixing tube, allowing the inlet of the mixing tube to be positioned selectively and accurately. In this manner, operation of the system may be tuned to optimize performance for changes in known operating parameters, such as abrasive size, abrasive type, orifice size and location, fluid pressure, and flow rate.

High-pressure fluid is provided to the system via a nozzle body coupled to the cutting head. To improve the accuracy of the assembly of the nozzle body with the cutting head, the bore of the cutting head is provided with pilot surfaces both upstream and downstream of threads in the cutting head bore. Likewise, an outer surface of the nozzle body is provided with corresponding threads and pilot surfaces upstream and downstream of the nozzle body threads. In this manner, the pilot surfaces of the cutting head engage the corresponding pilot surfaces of the nozzle body when the threads of the nozzle body and cutting head are engaged. Applicants believe that this use of two pilot surfaces longitudinally spaced from each other provides improved results over prior art systems that use only one pilot surface.

A shield is coupled to an end region of the cutting head assembly, surrounding an end region of the mixing tube, to contain the spray of the jet. In a preferred embodiment, a disk of wear-resistant material, such as polyurethane, is positioned in an inner region of the shield.

### BRIEF DESCRIPTION OF THE SEVERAL VIEWS OF THE DRAWINGS

FIG. 1 is a cross-sectional elevational view of an assembly for forming a high-pressure fluid jet, provided in accordance with the present invention.

FIG. 2 is a cross-sectional elevational view of an orifice mount provided in accordance with the present invention.

FIG. 3 is an alternative embodiment of an orifice mount provided in accordance with the present invention.

FIG. 4A is a cross-sectional elevational view of a cutting head provided in accordance with the present invention.

FIG. 4B is an enlarged detail view of a region of the cutting head shown in FIG. 4A.

FIG. 5 is a cross-sectional elevational view of a nozzle body provided in accordance with the present invention.

FIG. 6 is a cross-sectional elevational view of a mixing tube assembly provided in accordance with the present invention.

FIG. 7 is a partial cross-sectional elevational view of a mixing tube provided in accordance with the present invention.

FIG. 8 is a partial cross-sectional elevational view of a mixing tube provided in accordance with the present invention.

FIG. 9A is a partial cross-sectional elevational view of a mixing tube provided in accordance with the present invention.

FIG. 9B is a partial cross-sectional elevational view of the mixing tube assembly of FIG. 9A shown mounted in a cutting head body.

FIG. 10 is an enlarged elevational view of an orifice mount and a cutting head provided in accordance with the present invention, as shown in FIG. 1.

### DETAILED DESCRIPTION OF THE INVENTION

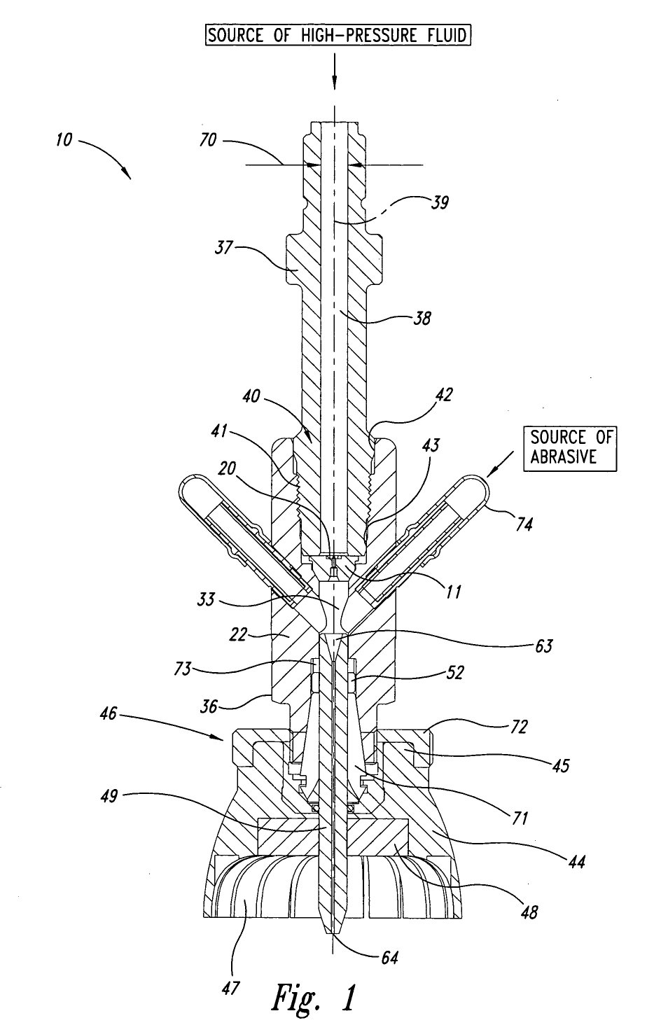

As illustrated in FIG. 1, an improved high-pressure abrasive waterjet assembly 10 is provided in accordance with a preferred embodiment of the present invention. (While the present invention is described herein in the context of an abrasive waterjet, it should be understood that the present invention is not limited to abrasive waterjets, but may be used to generate and manipulate any type of high-pressure fluid jet.) The assembly 10 includes a cutting head 22 that contains a jewel orifice 20 held by an orifice mount 11, and mixing tube 49. As is known in the art, high-pressure fluid is provided to the orifice 20 through nozzle body 37 to generate a high-pressure fluid jet, into which abrasives may be entrained via port 74. (The cutting head is provided with a second port to allow the introduction of a second fluid, for example air, or to allow the cutting head to be connected to a vacuum source or sensors.) The high-pressure fluid jet and entrained abrasives flow through mixing tube 49 and exit the mixing tube as an abrasive waterjet.

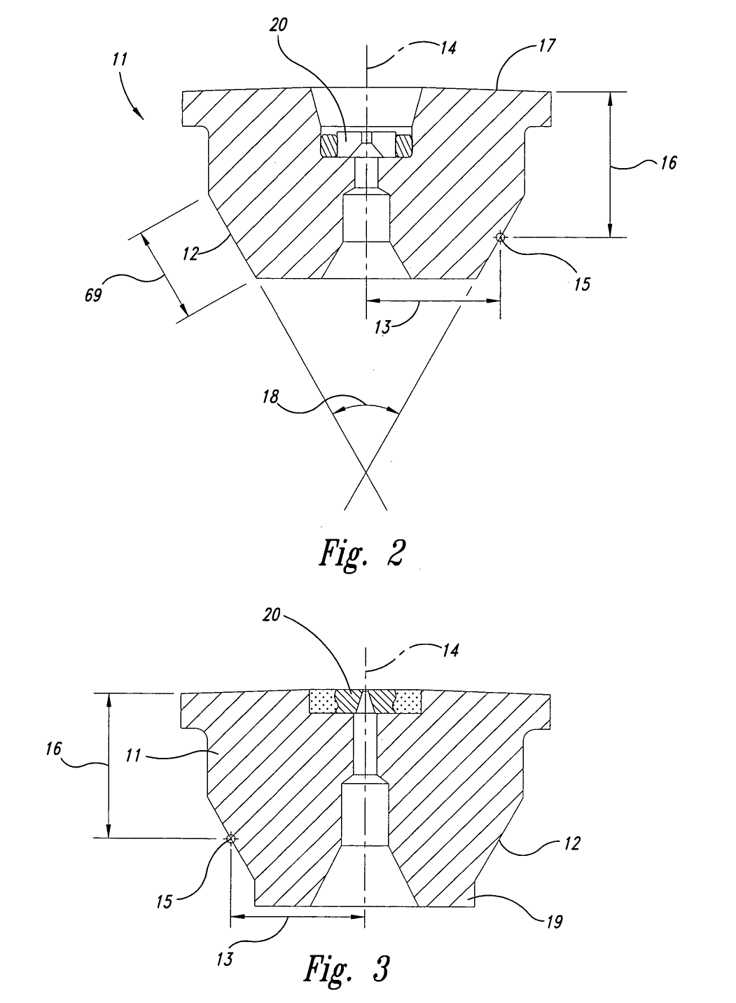

In accordance with the present invention, and as best seen in FIGS. 2 and 3, the orifice mount 11 has a frusto-conical outer surface 12 that seats against a corresponding frusto-conical wall 26 formed in a bore 23 of cutting head 22. As discussed above, it is desirable for the frusto-conical surface 12 of the orifice mount 11 to form an included angle 18 of 55-80°. This angle allows the orifice mount to be easily placed into and removed from the cutting head.

Applicants however, have further improved the performance of the orifice mount 11, by reducing the length 69 of the frusto-conical surface 12. As such, a radial distance 13 between a midpoint 15 of the frusto-conical surface 12 and the longitudinal axis or centerline 14 of the orifice mount 11 is reduced, as compared to conventional mounts. By minimizing the distance 13 between the longitudinal axis of the orifice mount and the center point 15 of the frusto-conical surface 12, deflection of the mount adjacent the jewel orifice 20 when under pressure is reduced. Furthermore, by reducing distance 13, the mount is more stable when subjected to pressure during operation of the system. To further improve the accuracy of the system, distance 16 between the midpoint 15 of the frusto-conical surface 12 and a top surface 17 of the orifice mount 11 is also maximized, thereby increasing the stability of the orifice mount under pressure. In a preferred embodiment, length 69 is 0.1-0.2 inch. In a preferred embodiment, distance 13 is 0.11-0.19, and preferably 0.15-0.185 inch. In a preferred embodiment, distance 16 is 0.15-0.3 inch.

As seen in FIG. 3, this preferred geometry for the orifice mount 11 is appropriate whether the jewel orifice 20 is recessed below the top surface 17 of mount 11, or is substantially flush with the top surface of the orifice mount. While the geometry provides improved stability and reduced deformation regardless of the type, location and method of securing the jewel orifice, applicants believe the increased stability achieved in accordance with the present invention is particularly beneficial when the jewel orifice 20 is mounted with a hard seal, for example, with a metallic seal.

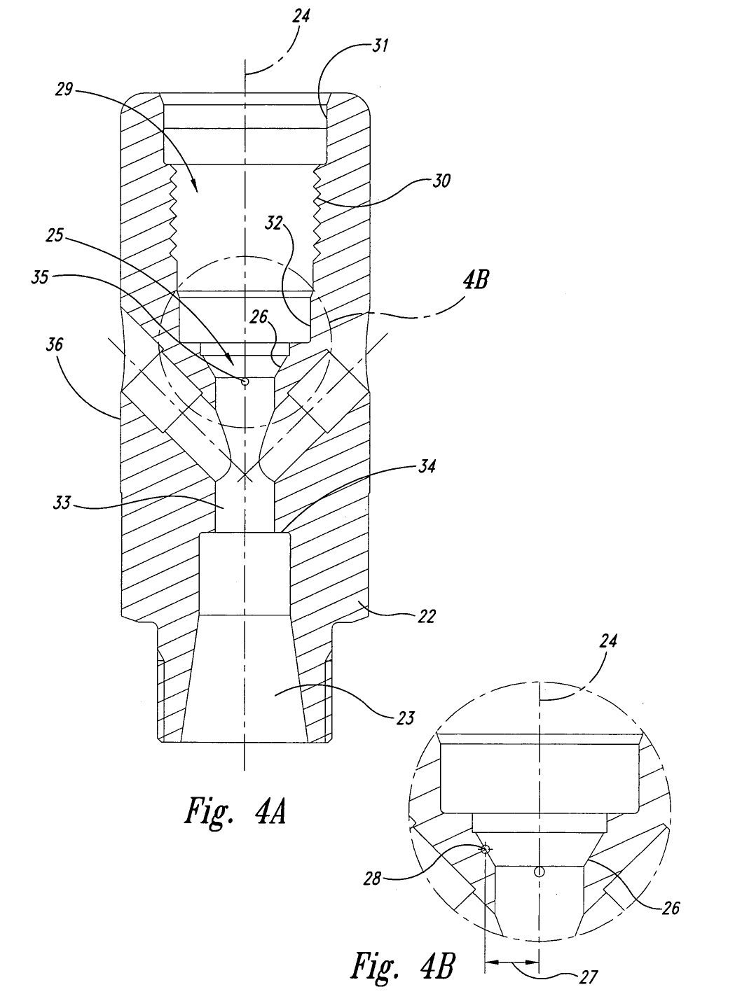

In an alternative embodiment, as shown in FIG. 3, the orifice mount 11 is provided with an annular member 19 extending parallel to the longitudinal axis 14 of the orifice mount, below the frusto-conical surface 12. When assembled into a cutting head, the annular member 19 may be aligned with a vent 35, as shown in FIG. 4A, that is open to atmosphere. In a preferred embodiment, vent 35 extends laterally from an outer surface 36 of the cutting head 22 to the bore of the cutting head, to a point adjacent the annular member of the orifice mount, downstream of the frusto-conical wall 26 of the cutting head. The provision of a vent 35 relieves a vacuum that typically forms below the orifice mount during operation of the high-pressure fluid jet system. A vacuum in this area causes reverse flow of abrasives and results in mixing inefficiency. This problem is reduced in accordance with the present invention.

In a preferred embodiment, the orifice mount 11 is made from a material having a 2% yield strength of above 100,000 psi. Examples of preferred materials include stainless steel PH 15-5, PH 17-4, and 410/416.

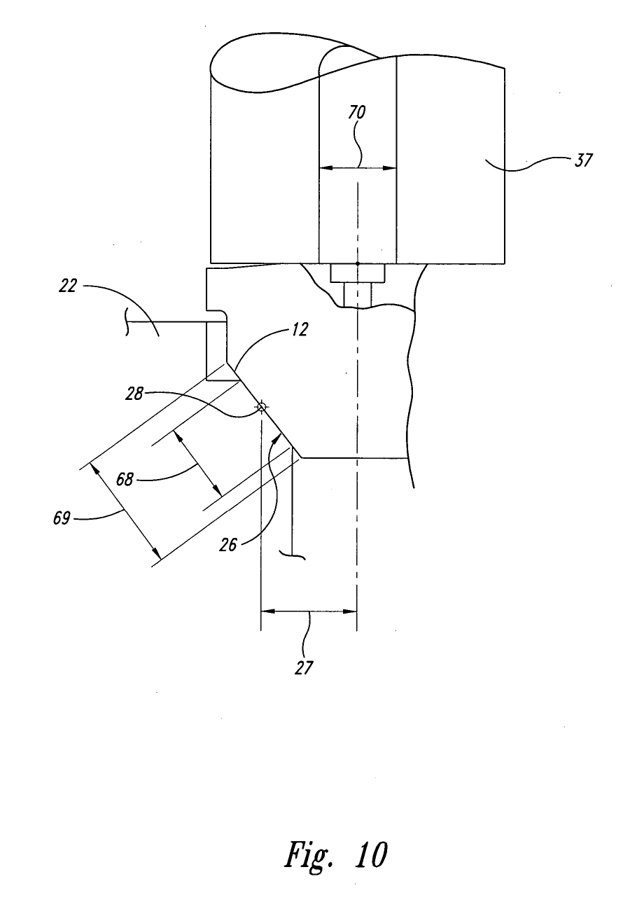

As best seen in FIGS. 4A, 4B, and 10, the cutting head 22 is provided with a bore 23 extending therethrough along a longitudinal axis 24. A first region 25 of the bore 23 forms a frusto-conical wall 26 in the cutting head body. Similar to the structure of the orifice mount 11, a radial distance 27 between the longitudinal axis 24 of the cutting head and a midpoint 28 of the frusto-conical wall 26 is reduced as compared to conventional cutting heads. In a preferred embodiment, distance 27 is 0.11-0.19 inch, and preferably 0.15-0.185 inch. It will be appreciated from the drawings that when the orifice mount 11 is positioned in the cutting head 22, the longitudinal axes of the orifice mount and the cutting head are aligned. Also, in a preferred embodiment, the midpoint 28 of the frusto-conical wall 26 approximately aligns with the midpoint 15 of frusto-conical surface 12 within a distance of 0.05 inch. Given that the length 68 of the frusto-conical wall 26 must be sufficient to support the load created by the pressure acting on a diameter 70 of a bore 38 of nozzle body 37, a ratio of length 68 to diameter 70 is 0.2-0.47. Similarly, in a preferred embodiment, a ratio of the length 69 of the frusto-conical surface 12 to diameter 70 is 0.2-0.47.

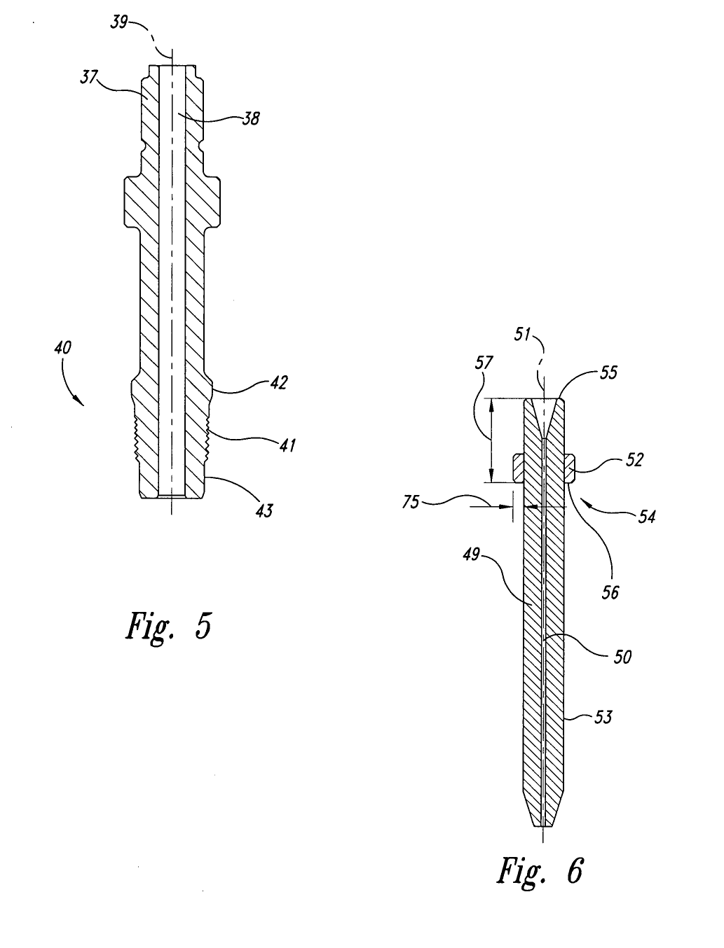

As discussed previously, high-pressure fluid is provided to the cutting head via nozzle body 37. As best seen in FIGS. 1 and 5, nozzle body 37 has a bore 38 extending therethrough along longitudinal axis 39. A first region 40 of nozzle body 37 is provided with a plurality of threads 41 on an outer surface of the nozzle body. The nozzle body 37 is further provided with a first pilot wall 42 upstream of the threads 41 and a second pilot wall 43 downstream of threads 41. As best seen in FIG. 4A, a region 29 of the bore 23 extending through cutting head 22 is provided with a plurality of threads 30. This region of the cutting head bore is also provided with a first pilot wall 31 upstream of threads 30 and with a second pilot wall 32, downstream of the threads 30. When the nozzle body 37 is screwed into cutting head 22, the first and second pilot walls of the cutting head engage the first and second pilot walls of the nozzle body, respectively, thereby increasing the accuracy of the alignment of the nozzle body and cutting head. Applicants believe that providing two pilot diameters, longitudinally spaced from one another, provides improved results over conventional systems that use only a single pilot surface.

As further illustrated in FIG. 4A, the bore 23 of cutting head 22 further defines a mixing chamber 33 and a shoulder 34, downstream of mixing chamber 33. In a preferred embodiment, a mixing tube 49, having a bore 50 extending therethrough along a longitudinal axis 51 to define an inlet 63 and an outlet 64, is positioned in the cutting head 22. As illustrated in FIG. 6, the mixing tube 49 is provided with a collar 52 rigidly fixed to an outer surface 53 of the mixing tube, in an upper region 54 of the mixing tube. To rigidly affix the collar to the mixing tube, a variety of methods may be used, including press fitting, shrink fitting, or a suitable adhesive material. The collar can also be formed during the manufacturing process for making the mixing tube and machined to final dimensions by grinding. The collar may be made out of metal, plastic, or the same material as the mixing tube.

The collar 52 has a sufficiently small outer diameter to slide upward through the bore 23 of the cutting head, yet the outer diameter of the collar is sufficiently large that it seats against shoulder 34 and prevents the mixing tube from being inserted further into the cutting head 22. In a preferred embodiment, as shown in FIG. 6, a wall thickness 75 of collar 52 is 0.01-0.2 inch. Because the collar 52 is rigidly fixed to an outer surface of the mixing tube, it precisely locates the mixing tube axially, within the bore of the cutting head 22, without the need for pins, inserts or other structure currently used in the art to locate the mixing tube. An o-ring 73 may be positioned between the collar 52 and shoulder 34 to seal the mixing chamber 33 from back flow.

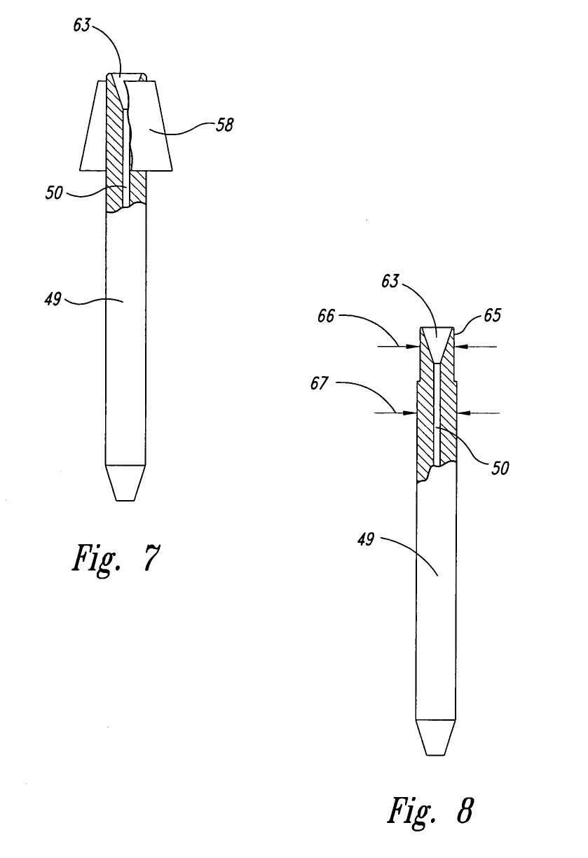

In a preferred embodiment, the collar 52 is cylindrical, and is used to position the mixing tube against the collet 71 and collet nut 72, that is selectively tightened and loosened against the assembly. As best seen in FIGS. 1 and 4A, the bore 23 of cutting head 22 is conical downstream of shoulder 34, to matingly engage the outer walls of collet 71. When the collet nut 72 is loosened, the collar 52 rests on the upper surface of the collet 71, preventing the mixing tube 49 from falling out of the cutting head 22, and from being pulled out of the cutting head. Alternatively, as shown in FIG. 7, the collar that is rigidly fixed to an outer surface of the mixing tube may be frusto-conical, such that when the mixing tube 49 is inserted into the distal end of the cutting head, the collar 58 locates the mixing tube both axially and radially.

Collar 52 may be rigidly fixed to an outer surface of the mixing tube 49 at any desired location, to precisely position the inlet 63 of the mixing tube at a specific location in the cutting head bore 23. While the exact location of collar 52 may be fine tuned depending on the operating parameters, in a preferred embodiment, a distance 57 between a top surface 55 of the mixing tube and a bottom surface 56 of collar 52 is 0.02-2.0 inch. In this manner, the tool tip accuracy of the system is improved.

In an alternative embodiment, as shown in FIG. 8, the mixing tube 49 is provided with a first cylindrical region 65 adjacent the inlet 63 to the mixing tube, the outer diameter 66 of the first cylindrical region 65 being less than the outer diameter 67 of the mixing tube 49 downstream of the first cylindrical region. In this manner, a step caused by the change in outer diameter of the mixing tube seats against the shoulder 34 in the cutting head 22, accurately locating the mixing tube in a selected axial position.

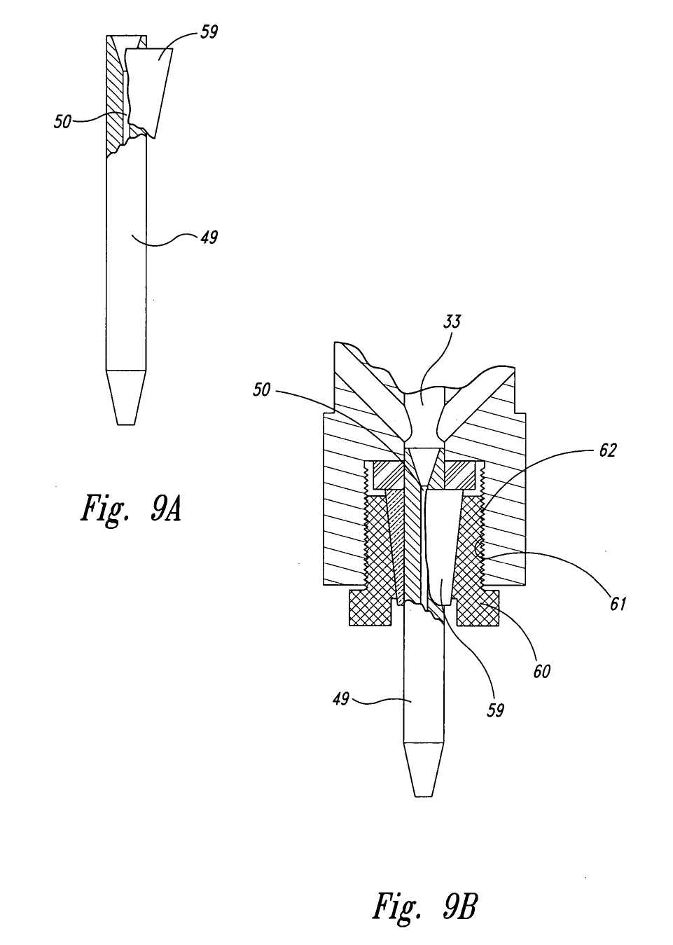

In an alternative embodiment, as illustrated in FIGS. 9A and 9B, a frusto-conical collar 59 is positioned on mixing tube 49, which in turn is held via an interference fit in a nut 60 that has threads 61 to engage a threaded inner surface 62 of a cutting head.

As seen in FIG. 1, the improved apparatus for generating a high-pressure fluid jet provided in accordance with the present invention, includes a shield 44 coupled to an end region 46 of the cutting head. The shield 44 is provided with a flange 45 that forms an interference fit with a groove in the collet nut 72. An annular skirt 47 extends downward from the flange 45 surrounding an end region of the mixing tube 49. In this manner, the shield substantially contains spray from the fluid jet. In a preferred embodiment, as shown in FIG. 1, a disk 48 of wear-resistant material, such as polyurethane, is positioned in an inner region of the shield 44.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A mixing tube for use in a high-pressure fluid jet system, comprising:
a mixing tube body having a bore extending therethrough along a longitudinal axis, and a collar rigidly fixed to an outer surface of the mixing tube in an upper region of the mixing tube, the collar being sized to slide upward through a bore of a cutting head and locate the mixing tube longitudinally in a desired location.

2. The mixing tube according to claim 1 wherein a distance from a top surface of the mixing tube body to a bottom surface of the collar is 0.02-2.0 inch.

3. The mixing tube according to claim 1 wherein a wall thickness of the collar is 0.01-0.2 inch.

4. The mixing tube according to claim 1 wherein an outer surface of the collar is substantially cylindrical.

5. The mixing tube according to claim 1 wherein an outer surface of the collar is substantially frusto-conical.

6. The mixing tube according to claim 1 wherein the collar is surrounded by a nut, an outer surface of the nut being threaded to engage a threaded inner surface of a cutting head.

7. A mixing tube for use in a high-pressure fluid jet system, comprising:
a mixing tube body having a longitudinal bore extending therethrough defining an inlet to the mixing tube and an outlet, a first cylindrical region of the mixing tube body adjacent the inlet having a first outer diameter that is less than a second outer diameter of the mixing tube body downstream of the first cylindrical region.
